(19) United States
(12) Patent Application Publication
(10) Pub. No.: US 2024/0005750 A1
(43) Pub. Date: Jan. 4, 2024

(54) EVENT-TRIGGERED CAPTURE OF ITEM IMAGE DATA AND GENERATION AND STORAGE OF ENHANCED ITEM IDENTIFICATION DATA

(71) Applicant: NCR Corporation, Atlanta, GA (US)

(72) Inventors: Eric Xavier Schoch, McKinney, TX (US); Marc Haberkorn, Raleigh, NC (US); Brent Vance Zucker, Roswell, GA (US); Jay Arcement, Atlanta, GA (US); Frank Hinek, Decatur, GA (US); Yogesh Kamat, Denver, CO (US); Amit Acharya, Plano, TX (US); Matthew Farrow, Canton, MA (US)

(21) Appl. No.: 18/217,459

(22) Filed: Jun. 30, 2023

Related U.S. Application Data
(60) Provisional application No. 63/358,096, filed on Jul. 1, 2022.
(60) Provisional application No. 63/420,233, filed on Oct. 28, 2022.

(51) Int. Cl. G07G 1/00; G06V 20/50; G06V 10/70

(52) U.S. Cl. CPC G07G 1/0036; G06V 20/50; G06V 10/70; H04N 7/188

(57) ABSTRACT

Systems, machines, methods, and computer-readable media are disclosed for detecting an event at a self-checkout (SCO) machine, determining that the event is an item-identifying event, triggering capture of image data of the item identified by the item-identifying event responsive to detecting the event and/or responsive to determining that the event is an item-identifying event, and generating enhanced item identification data that associates the captured image data with identifying information of the item. The enhanced item identification data may be stored in one or more datastores, which may include a local datastore in a retail environment in which a self-checkout machine is located or a remote datastore such as cloud-based data storage.

### TECHNICAL FIELD

This disclosure pertains generally to self-checkout (SCO) systems, and more particularly to in-the-field, event-triggered capture of item image data at a SCO machine and generation of enhanced item identification data therefrom.

### BACKGROUND

Individuals are increasingly desiring more streamlined, efficient, and frictionless customer experiences in the retail, hospitality, and banking service sectors. In retail environments, for instance, self-checkout (SCO) machines are becoming increasingly popular among customers, who prefer the reduced wait times and expedited checkout process they offer as compared to employee-manned checkout counters. Moreover, the COVID-19 global pandemic has further accelerated customer adoption of SCO technology, as customers seek to social distance and mitigate the risk of disease transmission. SCO kiosks are also becoming more popular in the hospitality sector, enabling customers to streamline check-in and check-out processes across a range of service industries such as lodging, food and drink service, and so forth.

Improving the efficiency with which items are identified during the self-checkout process remains a continuing technical challenge. Various approaches have been adopted that are geared towards making the process more frictionless, reducing the burden on the customer, and improving the overall customer experience. These approaches, however, continue to suffer from various technical drawbacks.

### SUMMARY

Systems, machines, methods, computer-readable media, processes, techniques, and methodologies are disclosed for detecting an event at a self-checkout (SCO) machine, determining that the event is an item-identifying event, triggering capture of image data of the item identified by the item-identifying event responsive to detecting the event and/or responsive to determining that the event is an item-identifying event, and generating enhanced item identification data that associates the captured image data with identifying information of the item. The enhanced item identification data may be stored in one or more datastores, which may include a local datastore in a retail environment in which the SCO machine is located or a remote datastore such as cloud-based data storage. It should be appreciated that image data, as that term is used herein, may be include images and/or video data.

In some embodiments, the enhanced item identification data may be used as feedback data to re-train or enhance the item identification capabilities of a computer vision-based machine learning model. In some embodiments, the enhanced item identification data may be shared with a third party. In some embodiments, the enhanced item identification data may be annotated (either manually or through an at least partially automated process) to label various objects present in the image data. For example, objects present in the image data may be manually annotated to distinguish them from the item identified by the item identifying information of the enhanced item identification data.

In some embodiments, the item-identifying event may be a scan event at a SCO machine. For instance, the item-identifying event may be a scan of a barcode or other marking present on an item or item packaging using a bioptic (flatbed scanner) of the SCO machine, a handheld scanner, or the like. A processor of the SCO machine may determine that the scan event is an item-identifying event upon receiving, as input, output from the scanner that is representative of information contained within an item barcode and determining that the received information is linked to identifying information of a particular item (e.g., a Stock Keeping Unit (SKU). For instance, the processor may access a database that stores records that link or otherwise associate information contained within item barcodes (and which is ascertainable from the received scanner output) with item identifiers such as SKUs.

In other embodiments, the item-identifying event may not be a scan event, but rather may be another type of event that nonetheless serves to identify a particular item. For instance, in some embodiments, the item-identifying event may be a user selection of a particular item from a collection of candidate items identified on a display of the SCO machine (e.g., thumbnail images of items, a drop-down menu of item names, etc.). As another non-limiting example, the item-identifying event may be other user input provided to the SCO machine that identifies an item such as free-form text input provided via a touch display of the SCO machine, voice input to the SCO, or text and/or voice input to a mobile device (e.g., a user's smartphone), which is then communicated to the SCO via a wireless connection such as a Bluetooth connection.

In some embodiments, the image of the item may be captured responsive to detecting any of a set of predetermined events that can occur at a SCO machine, even prior to identifying the item corresponding to the event. The predetermined events may be, for example, events known to be item-identifying events. For example, the image of the item may be captured responsive to detecting a scan event, potentially prior to actually determining the SKU associated with the barcode information obtained by the scanner. As another non-limiting example, the image of the item may be captured responsive to detecting a user touch selection of a SCO display (or other user input to the SCO) in combination with detecting a weight change on a SCO weighing scale, detecting an item within a field-of-view of one or more cameras, or the like. In any case, the image data may then be associated with the item's SKU after it is determined based on the scanned barcode information, user input, or the like. In other embodiments, the image of the item may be captured after the item identifying information (e.g., SKU) is determined. In some embodiments, the image data may be captured by a camera that is embedded within a SCO scanner.

Systems, machines, methods, computer-readable media, processes, techniques, and methodologies are disclosed for generating enhanced item identification data from input received at a SCO machine. One or more cameras may capture images/video of one or more items. In some embodiments, multiple items may be placed on a platform of the SCO machine or otherwise within proximity of the SCO machine (e.g., within a shopping cart, shopping basket, or the like), and the cameras—which may be positioned at various heights and angles with respect to each other and with respect to other components of the SCO—may capture image data of the items. This image data may be provided as input to a learning model. The learning model may be, for example, a computer vision machine learning model trained to output a corresponding item identifier (e.g., a SKU) for each imaged item based on input image(s) of the items. In some embodiments, the machine learning model may output a confidence value along with a candidate item identifier, the confidence value indicating a level of confidence that the candidate item identifier is a true identifier for the corresponding item in the image.

In some scenarios, the machine learning model may output item identification data (e.g., an item identifier) for an imaged item that does not have an acceptable confidence level associated therewith or may not output an item identifier at all if the confidence is particularly low. In such scenarios, according to embodiments of the disclosed technology, additional learning input may be received dynamically in-the-field as input to the SCO machine or alternative machine learning input, and enhanced item identification data may be generated based on the additional learning input. The additional learning input may provide enough confidence to link a particular item identifier (e.g., SKU) to a particular imaged item. This association may be represented in the enhanced item identification data.

The additional learning input may take the form of scanner input from a scan of a marking (e.g., barcode) on the item and/or a customer selection from among candidate items presented to the customer on a SCO display, for example. In other embodiments, the additional learning input may be an image captured of a barcode. The barcode image may be captured by one or more cameras integrated with the SCO machine, by a customer's mobile device camera, or the like. In still other embodiments, the additional learning input may be an item classification output of an alternative computer vision learning model. In some embodiments, the machine learning model that failed to yield a SKU at an acceptance confidence level may be re-trained based on the enhanced item identification data to obtain a more refined model capable of identifying items with greater accuracy and/or capable of identifying a larger set of items with at least the minimum acceptable confidence level.

Any of the methods, systems, and/or computer program products disclosed herein can be combined in any manner to obtain additional embodiments of the technology disclosed herein (hereinafter “disclosed technology”). In particular, any feature, component, aspect, or the like of a given embodiment can be combined with any other feature, component, aspect, or the like of any other embodiment to obtain another embodiment of the disclosed technology.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the disclosed technology are set forth with particularity in the appended claims. A better understanding of the features and advantages of the disclosed technology will be obtained by reference to the following detailed description that sets forth illustrative embodiments, in which the principles of the technology are utilized, and the accompanying drawings of which:

FIG. 1 is a block diagram of a networked architecture for implementing a self-checkout (SCO) process within a retail environment in accordance with example embodiments of the disclosed technology.

FIG. 2 is a block diagram that depicts example components of a SCO machine in accordance with example embodiments of the disclosed technology.

FIG. 3 is a block diagram that depicts example components of an interactive customer interface terminal of a SCO machine in accordance with example embodiments of the disclosed technology.

FIG. 4 is a hybrid flow/block diagram illustrating a process for generating enhanced item identification data in accordance with example embodiments of the disclosed technology.

FIG. 5 is a flowchart of an illustrative method of generating enhanced item identification data in accordance with example embodiments of the disclosed technology.

FIG. 6 is a flowchart of a specific example implementation of the method of FIG. 5 in accordance with example embodiments of the disclosed technology.

FIG. 7 is a flowchart of an illustrative method of event-triggered capture of item image data in accordance with example embodiments of the disclosed technology.

### DETAILED DESCRIPTION

Embodiments of the disclosed technology include systems, machines, methods, computer-readable media, processes, techniques, and methodologies for generating enhanced item identification data from learning input received at a self-checkout (SCO) machine. One or more cameras may be provided—either integrated within a housing of the SCO machine or external thereto—to capture images of an item. The item may be one that a customer seeks to purchase from a retail store, for example. In some embodiments, multiple items may be placed on a platform of the SCO machine or otherwise within proximity of the SCO machine (e.g., within a shopping cart, shopping basket, or the like), and the cameras—which may be positioned at various heights and angles with respect to each other and with respect to other components of the SCO—may capture multiple images of the items. In some embodiments, the image data may include video data. In some embodiments, other forms of data (e.g., radio frequency identification (RFID) data) corresponding to the items may also be captured.

The cameras may include any of a variety of types of image sensors that operate to convert the variable attenuation of light waves (as they pass through or reflect off objects) into signals that convey information. The cameras may include digital and/or analog electronic imaging devices. The electronic image sensors included in one or more of the cameras may include charge-coupled devices (CCDs), which are based on metal-oxide-semiconductor (MOS) capacitors, and/or active-pixel sensors such as complementary metal-oxide-semiconductor (CMOS) sensors, which are based on MOS field-effect transistors (MOSFETs).

The image data (and optionally other forms of data) may be provided as input to a learning model. The learning model may be, for example, a computer vision-based machine learning model trained to output an item identifier for an item (e.g., a Stock Keep Unit (SKU)) based on an input image of the item. More generally, any suitable machine learning model/classifier configured to perform object detection/classification may be employed. In some embodiments, the machine learning model is trained using training data, which may include labeled/annotated image data that associates images of items with known SKUs for the items. In some embodiments, the machine learning model may output a confidence value along with a candidate item identifier, the confidence value indicating a level of confidence that the candidate item identifier is a true identifier for the corresponding item in the image.

In some scenarios, the machine learning model may output item identification data (e.g., a candidate item identifier) for an imaged item with an associated confidence value that is below an acceptable level of confidence for the transaction. Further, in some scenarios, the machine learning model may not output an item identifier at all if the confidence in that determination is particularly low. In such scenarios, according to embodiments of the disclosed technology, additional in-the-field learning input may be received, and enhanced item identification data may be generated based on the additional learning input. The additional learning input may provide enough confidence to link a particular item identifier (e.g., SKU) to a particular imaged item. This association may be represented in the enhanced item identification data.

In some embodiments, a customer/user may be prompted for the additional learning input. For instance, if a SKU outputted by the machine learning model does not have an associated confidence value/level that satisfies (e.g., is greater than or equal to) a first threshold confidence level corresponding to a minimum confidence required to accept the item identifier as a true identifier of an imaged item for the purposes of proceeding with the transaction, then a customer may be prompted to provide the additional learning input at the SCO machine. In those example scenarios in which the confidence value for the SKU does not satisfy the first threshold confidence level but does satisfy a second lesser threshold confidence level, a graphical representation (e.g., a thumbnail image) of the item associated with the SKU (and potentially graphical representations of one or more related items) may be presented on a display of the SCO machine or a display of the customer's smartphone or wearable device. The customer may then be prompted to select the representation that corresponds to the actual item. If none of the candidate items correspond to the actual item, the customer may be able to provide free-form text entry to specify the actual item. Alternatively, the customer may be able to request that additional related items be displayed until the correct item becomes selectable.

In other example scenarios, such as those in which the SKU outputted by the machine learning model fails to satisfy even the second threshold confidence level, the customer may be prompted to provide scanner input to the SCO machine. In particular, the customer may be prompted to utilize a barcode scanner to scan a linear barcode on the item packaging. In other example scenarios, other machine-readable markings/indicia may be present on the item packaging, and the customer may be prompted to utilize another type of scanning device to read the markings/indicia. For instance, in some cases, item packaging may include a 2-dimensional (2D) matrix barcode (e.g., a quick response (QR) code) capable of being read by a reader integrated with the SCO machine, a dedicated peripheral device that is not integrated into the SCO, but which is communicatively coupled to the SCO via one or more wired and/or wireless connections, or a customer device such as smartphone. In still other example scenarios, the physical item identifier present on the item packaging may be simply a string of alphanumeric characters, which can be read by one of cameras integrated/coupled to the SCO or a customer's smartphone camera.

In still other embodiments, the additional learning input may be an item classification output of an alternative computer vision-based learning model. For instance, another computer vision-based learning model, which may have been trained on a different initial training dataset, may be used to analyze the images, and provide a SKU output. As previously noted, the additional learning input, however it may be received, may be embodied as enhanced item identification data. Further, regardless of the source of the additional learning input, in various embodiments, the machine learning model that failed to yield a SKU at an acceptance confidence level may be re-trained based on the enhanced item identification data to obtain a more refined model capable of identifying items with greater accuracy and/or capable of identifying a larger set of items with at least the minimum acceptable confidence level.

An overview of various example embodiments of the disclosed technology has been presented above. A more detailed discussion of these and other embodiments of the disclosed technology will now be provided. It should be appreciated the any embodiments individually described herein can be combined in any manner to yield additional embodiments of the disclosed technology. It should further be appreciated that discussion herein of one or more aspects of any particular embodiment shall not be construed as an admission that such aspect(s) are not also shared by other embodiments of the disclosed technology.

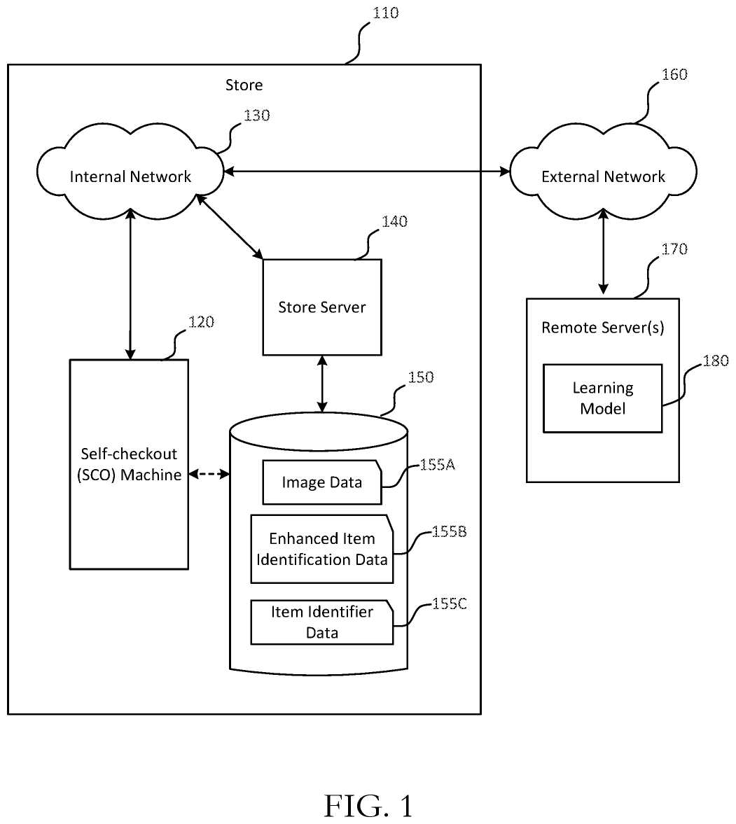

FIG. 1 is a block diagram of a networked architecture 100 for implementing a self-checkout (SCO) process within a retail environment in accordance with example embodiments of the disclosed technology. A portion of the architecture 100 is provided in a retail environment 110, which may include a brick-and-mortar store such as a supermarket, a discount store, a wholesale retailer, a department/specialty store, a gas station, or the like). A SCO machine 120 (synonymously referred to herein as “SCO”) is provided within the store 110. While a single SCO 120 is depicted in FIG. 1, it should be appreciated that multiple SCOs 120 may be provided.

SCO 120 may be configured to receive digital information, such as from a bar code of an item or from user input received at a display of the SCO 120 and may process the information in various ways. The SCO 120 may also be configured to receive financial transaction information from a payment mechanism such as a mobile device or a financial card, such as a credit, debit, or gift card. The electronic financial transaction may be contactless, such as via near field communication (NFC) or optical character recognition (OCR), or the transaction may occur via a card reader or other mechanism for reading a financial card. The SCO 120 may thus obtain financial account-related information from an individual via one or more of a number of input mechanisms.

The SCO 120 may communicate with a store server 140, and optionally, other SCOs in the store 110, via an internal network 130. The SCO 120 may match the item information (e.g., bar code) of a scanned item with corresponding pricing information. To match the information, the SCO 120 may access data stored in a memory of the SCO 120, or may communicate, e.g., via the internal network 130, with another entity (e.g., the store server 140) to obtain the data, which may then be displayed on a display of the SCO 120.

The SCO 120 may also communicate with other internal and external entities directly, via the internal network 130, or through an external network 140. The SCO 120 may communicate, for example, via one or more micro, fico or nano base stations (BSs). Multiple SCOs 120 may communicate with each other and external devices using any of a number of different techniques, such as WiFi, Bluetooth, Zigbee, or 3rd Generation Partnership Project (3GPP) network technologies, to name a few. In some cases, the SCO 120 may match the item information and pricing information with another entity, e.g., with the internal store server 140 via the internal network 130 and/or with a remote server 170 via the external network 160. The SCO 120 may, in addition, capture financial information related to a transaction and attempt to confirm the information by transmitting the captured financial information to one or more servers via at least one of internal network 130 and one or more external networks 160.

In various embodiments, the networks 130, 160 may include one or more wired and/or wireless networks. The external network 140 may be, for example, the Internet or a private network. The internal network 130 may be, for example, a wired or wireless local area network (LAN). In some embodiments, the internal network 130 may not be provided, and the SCO 120 may communicate directly with one or more external networks 160. In other embodiments, SCO 120 may be able to communicate with an external network 160, but only indirectly through the store server 140. It should be appreciated that other equipment, such as base stations, routers, access points, gateways and the like used in communicating through the networks 130, 140 are not shown for convenience.

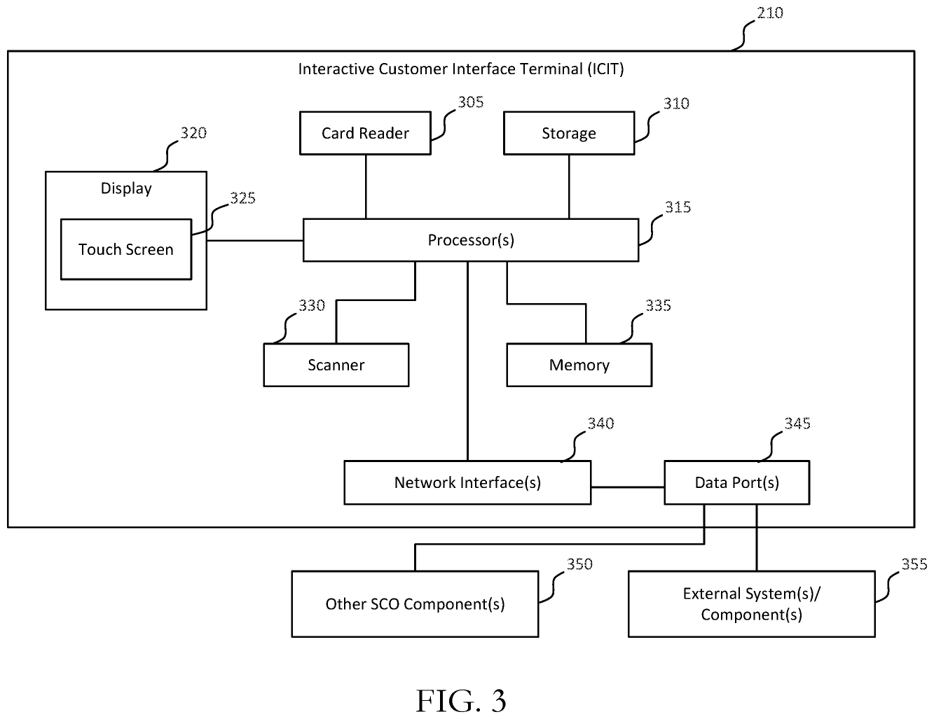

One or more datastores 150 may also be provided at the store 110. SCO 120 may be configured to access the datastore(s) 150 via a directed wired connection, via the internal network 130, and/or indirectly, via store server 140. The datastore(s) 150 may include any storage configured to retrieve and store data. Some examples of such storage include, without limitation, flash drives, hard drives, optical drives, cloud storage, and/or magnetic tape. Datastore(s) 150 may include, but are not limited to, databases (e.g., relational, object-oriented, etc.), file systems, flat files, distributed datastores in which data is stored on more than one node of a computer network, peer-to-peer network datastores, or the like. The datastore(s) 150 may store one or more database managements systems (DBMS). The DBMS may be loaded into a memory of the SCO 120 (depicted and described in reference to FIG. 3) and may support functionality for accessing, retrieving, storing, and/or manipulating data. The DBMS may use any of a variety of database models (e.g., relational model, object model, etc.) and may support any of a variety of query languages. The DBMS may access data represented in one or more data schemas and stored in any suitable data repository.

Various types of data may be stored in the datastore(s) 150. Image data 155A may be stored in the datastore(s) 150, for example. The image data 155A (which may include still images and/or video data) may be captured by one or cameras integrated with SCO 120 or provided externally to SCO 120 within the store 110. The image data 155A may include images of items captured in real-time during transactions. Further, in some embodiments, the image data 155A may include annotated/labeled image data that associates known item identifiers (e.g., SKUs) with corresponding images of the items, and which may have been provided as training data to a learning model 180 such as a computer vision-based machine learning model.

Enhanced item identification data 155B may also be stored in the datastore(s) 150. The enhanced item identification data 155B may be generated, for example, in those scenarios in which the item identification performed by the learning model 180 is not sufficient to determine an item identifier of an imaged item with a minimum desired level of confidence. In particular, the enhanced item identification data 155B may be generated responsive to receiving additional learning input in the form of a barcode or other machine-readable indicia scan representing a particular SKU, other customer input to SCO 120 (e.g., input entered into a display of the SCO 120 that represents selection of a particular item with a corresponding known SKU), or SKU output provided by an alternative learning model. The enhanced item identification data 155B may include a stored association (e.g., linking data) that links a SKU identified based on the additional learning input to an image 155A of the corresponding item.

In some embodiments, the enhanced item identification data 155B may represent a mapping between item identifier data 155C and corresponding image data 155A. The item identifier data 155C may include data that associates item identifiers such as SKUs with the names, visual/graphical representations (e.g., thumbnail images), descriptions, or the like of corresponding items available to be transacted for. In some embodiments, the enhanced item identification data 155B may link item identifiers (e.g., SKUs) in the item identifier data 155C to corresponding images in the image data 155A for at least those items for which the learning model's 180 output failed to satisfy an acceptable confidence threshold.

The learning model 180 is illustratively depicted as being hosted/executing on one or more remote servers 170. A same entity or different entities may operate the remote server(s) 170, the store server 140, and/or SCO 120. In some embodiments, image data 155A captured by cameras integrated with or otherwise provided in proximity to SCO 120 may be sent via internal network 130 and external network 160 to remote server(s) 170. The image data 155A may then be provided as input to a computer vision-based machine learning model 180 trained to detect and recognize item(s) in the image data 155A and output corresponding SKU(s) for the item(s). As previously noted, the model 180 may be further configured to output confidence values associated with the SKU outputs. In some embodiments, the image data 155A may not be housed locally within the datastore(s) 150, but rather may be stored on the remote server(s) 170 or remote datastore(s) accessible by the remote server(s) 170. In other embodiments, the image data 155A may be stored both locally and remotely. In some embodiments, the learning model 180 (and/or one or more other machine learning models) may additionally, or alternatively, reside and execute locally at the store 110 such as on store server 140 or on a storage medium of SCO 120.

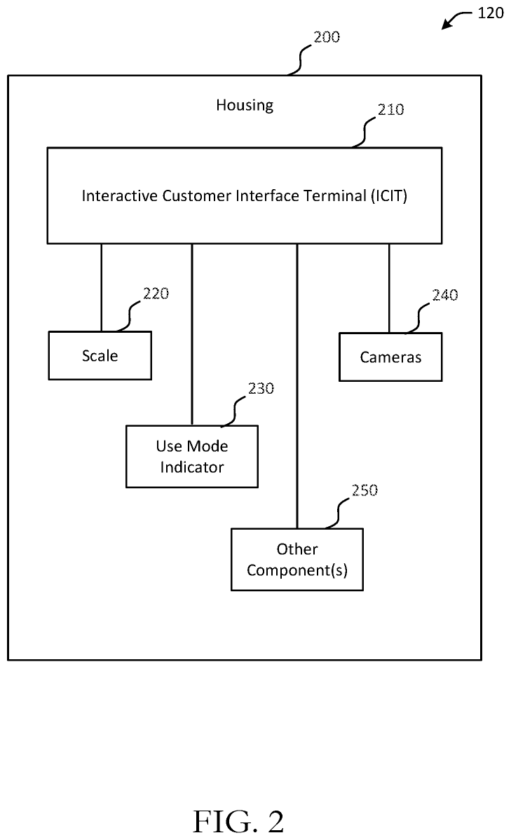

Referring now to FIG. 2, example components of SCO 120 of FIG. 1 are shown. SCO 120 includes a housing 200 that supports/has an interactive customer interface terminal (ICIT) 210, a scale 220, one or more cameras 240, and a use mode indicator 230. Optionally, the housing 200 may additionally support/have other components 250 such as a cash module. The housing 200 supports the ICIT 210 by, for example, being mounted thereon or in a manner that allows easy access to and use of the ICIT 210 by a consumer. As explained more fully below, the interactive customer interface terminal 210 presents instructions and/or data from the retail establishment to the customer, allows customer input of various choices and customer data, scans or obtains machine-readable indicia from an item, and obtains/assists in receipt of payment from the customer.

The scale 220 is in communication with the ICIT 210 and is operative to obtain a weight of an item or items placed thereon. In particular, the scale 220 may be operative to obtain the weight of items (e.g., cumulative weight of items) during a purchase transaction. More particularly, the scale 220 may be operative to obtain the cumulative weight of items placed thereon, including when the items are contained within a bag or the like. The scale 220 may provide a security check of items bagged against those items that were scanned and/or detected within image data analyzed by the computer vision learning model 180. The cameras 240 may be in communication with ICIT 210 and operative to obtain still pictures and/or (real-time) video (image data) of a purchase transaction being performed at the SCO 120. The cameras 240 may obtain image data of the customer, items associated with the purchase transaction, the scanning process, the bagging process, the weighing process, the payment process, and more.

SCO 120 also includes a use mode indicator 230 communicatively coupled to the ICIT 210. The use mode indicator 230 may be operative to indicate whether SCO 120 is currently in use as part of an active transaction process. The use mode indicator 230 may provide audible, visual, or a combination of audible and visual signals. The use mode indicator 230 may utilize any of the above to indicate non-use as well. A non-use indicator 230 may be provided after a predetermined period of time has elapsed since an event, or upon the occurrence of a particular event. SCO 120 may optionally include other components 250 such as a cash module. The cash module may be operative to accept and dispense cash as payment for a purchase transaction.

SCO 120 is operative to allow purchase transactions to be performed or conducted thereon. Additionally, SCO 120 is operative to monitor the purchase transactions by item weight and video security measures. SCO 120 is configured to perform a number of retail functions, particularly unassisted or “self-service” checkout functions, which includes checkout functions or transactions that are performed automatically by a checkout system and/or by a customer or in response to customer input/actions, without the assistance of store personnel. For example, a self-service checkout (purchase) function or transaction may be performed on SCO 120 in response to a customer himself or herself scanning or otherwise entering items for purchase into the ICIT 210 of SCO 120, and thereafter depressing a payment key on ICIT 210 that indicates the manner by which the customer intends to pay for such items (e.g., by interaction with a credit/debit/smart card reader and/or currency acceptor). According to example embodiments of the disclosed technology, a self-service checkout function of SCO 120 also includes an automated computer vision-based item detection and identification function performed by learning model 180 based on input image data 155A captured by cameras 240 integrated with SCO 120 or otherwise present in the store 110 to capture images/video of transacted items.

ICIT 210 provides various functions for SCO 120. In an aspect, ICIT 210 provides the main processing for the various components and software of SCO 120. ICIT 210 also provides the main interaction between the customer and SCO 120. In particular, ICIT 210 provides various functionality for SCO 120, such as scanning functionality, payment acceptance functionality, input/output functionality, and information/data terminal functionality.

Referring now to FIG. 3, components of ICIT 210 in an example implementation are shown. ICIT 210 may be a user interface terminal or an interactive customer interface terminal for receiving input from and presenting information to a customer. ICIT 210 includes one or more processors 315 (referred to hereinafter in the singular for ease of explanation) which may include, without limitation, a processing unit, a processing core, processing logic, or the like, and optionally, associated components. More generally, processor 315 represents any manner of providing electronic processing logic for processing and/or performing the various features, functionality, and the like on SCO 120. Processor 315 may be communicatively coupled to memory 335 and storage 310. Program instructions, executable by processor 315 for controlling operations of SCO 120, may be stored in storage 310 and load into memory 335 for execution by processor 315. The memory 335 may be any type of available non-volatile and/or volatile memory including, without limitation, cache memory, random access memory (RAM), read-only memory (ROM), electrically erasable programmable read-only memory (EEPROM), dynamic random access memory (DRAM), and the like depending on the particular application and functionality. Storage 310 may include any suitable non-volatile storage including, without limitation, hard disk storage, solid state storage, tape storage, or the like.

ICIT 210 further includes a display/monitor 320 via which retail information may be presented to a customer during operation of SCO 120. For example, transaction information such as item price, item description, total amount of the transaction, instructions, etc. may be displayed to the customer via the display/monitor 30 during operation of SCO 120. Moreover, instructions may be displayed on the display/monitor 320 that assist or otherwise guide the customer through operation of SCO 120. The display/monitor 320 may utilize any suitable display technology.

The display/monitor 320 of ICIT 210 preferably incorporates or includes a touch screen 325 configured to generate data signals (e.g., voltages, currents, etc.) responsive to pressure applied to the touch screen 325 due to touch events. The touch screen 325 may encompass the entire display area of the display/monitor 320 or may cover only a portion thereof. A customer may utilize the display/monitor 320 to input information into SCO 120. Such information may be received at the display/monitor 320 in response to a prompt from SCO 120 (e.g., as a response to a question or next action to be taken) or at the motivation of the customer. For example, the customer may provide input to the touch screen 325 that corresponds to selection of a candidate item (e.g., an image or other representation of an item presented on the display/monitor 320).

Representations of a set of candidate items may be presented on the display 320 based on a customer's historical item selections in past transactions. Representations of candidate items may also be presented on the display 320 in response to the learning model 180 failing to identify an item's SKU from an input image of the item with a suitable level of confidence using its object detection/item identification capabilities. For example, if the learning model 180 outputs a SKU for an item in an input image, where the confidence level for that SKU is below a first threshold value but above a second lesser threshold value, then a representation of the item corresponding to that SKU, along with representations of one or more related items, may be presented on the display 320, and the customer may be prompted to select the correct item. In some embodiments, the image of the item for which the learning model 180 was unable to ascertain a corresponding SKU with an acceptable confidence level, and in connection with which the customer is prompted for input to identify the correct item (and thus the correct SKU), may be presented on the display 320 as well. In some embodiments, the item for which the learning model 180 was unable to ascertain a corresponding SKU with an acceptable confidence level may be made conspicuous to the customer (e.g., surrounded by a bolded or colored bounding box) if the image contains multiple items. The customer input (e.g., customer selection of a representation of a particular candidate item via input provided to the touch screen 325) may then either confirm the low confidence SKU output of the learning model 180 or reveal that the imaged item is a different item (and thus a different SKU) than what the model 180 determined.

In some embodiments, the customer may also manually enter retail information such as item codes (e.g., barcodes such as Universal Product Codes (UPCs), QR codes, etc.), item names, item descriptions, item quantities, etc. into SCO 120 by use of the touch screen 325 associated with the display/monitor 320. This may occur, for example, if none of the candidate items presented to the customer actually match an imaged item for which the learning model 180 was unable to determine a corresponding SKU with a suitable level of confidence. In addition, the customer may indicate his or her preferred method of payment (e.g., cash, credit card, debit card, etc.) and/or PIN number by touching the appropriate area of the touch screen 325. A portion of the touch screen 325 associated with the display/monitor 320 may also be used as a signature capture area. In some cases, a stylus (not shown) may be used to input the signature of a customer for a card purchase or other type of purchase requiring a signature. The display/monitor 320 may provide pictures, video, data, and/or other information (collectively data) to the customer during the checkout transaction as appropriate or desired. This data may require responses or actions by the customer that are implemented via the ICIT 210 or may require only passive viewing.

ICIT 210 also includes a scanner 330 communicatively coupled with the processor 315. The scanner 330 is operative to scan or read an item identifier (product identification code) such as a UPC barcode, a QR code, industrial symbol(s), alphanumeric character strings, or other indicia associated with an item to be purchased. The scanner 330 may be integral with ICIT 210 but may be provided separately but capable of communicating with ICIT 210 over one or more wired and/or wireless connections.

The scanner 330 may include a light source (not shown) such as a laser, a rotating mirror (not shown) driven by a motor (not shown), and a mirror array (not shown). In operation, a laser beam from the laser reflects off the rotating mirror and mirror array to produce a pattern of scanning light beams. As the machine-readable indicia on an item is passed over in front of the scanner 330, the scanning light beams scatter off the product identification code and return to the scanner 330, where they are collected and detected. The reflected light is then analyzed electronically in order to determine whether the reflected light contains a valid indicia pattern. If a valid indicia pattern is detected or present, the machine-readable indicia (e.g., a product identification code) may then be utilized to retrieve product information/data associated with the item (e.g., the price of the item, item description, or the like). The scanner 330 may also be used to read various information to perform various other functions.

ICIT 210 may further include network interface(s)/communications logic 340 in communication with the processor 315 and with one or more data ports 345. The data port(s) 345 may enable ICIT 210 to communicate with other SCO components 350 and external systems and/or components 355, as necessary or appropriate. The data port(s) 345 may also include a diagnostics port and/or other ports as necessary and/or appropriate. The network interface(s) 340 may be coupled to a network (e.g., internal network 130 and/or external network 160). The network interface(s) 340 may support communication over an Ethernet connection, a serial connection, a parallel connection, and/or an ATA connection. The network interface(s) 340 may also support wireless communication (e.g., 802.11 a/b/g/n, WiMax, LTE, WiFi, etc.). It will be apparent that the communication network interface(s) 340 may support many wired and wireless standards.

ICIT 210 also includes a card reader 305 or other point-of-sale (POS) device that is operative to obtain data and/or information from a credit card, a debit card, a smart card, a smartphone digital wallet, or the like. This includes magnetic, electronic, and wireless reading capabilities. Information obtained by the card reader 305 is typically used for payment. However, the card reader 305 may also magnetically or electronically read bonus or store cards, gift cards, and/or the like. The processor 315 processes the information obtained by the card reader 305 accordingly.

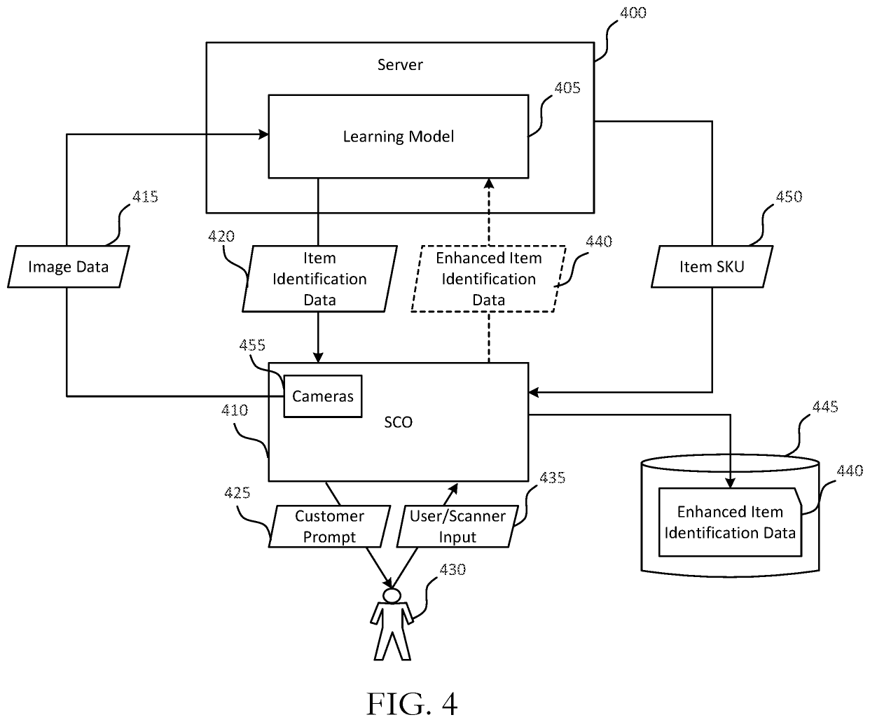

FIG. 4 is a hybrid flow/block diagram illustrating a process for generating enhanced item identification data in accordance with example embodiments of the disclosed technology. A server 400 is shown in FIG. 4. The server 400 may be a particular implementation of a remote server 170 or a store server 140. A learning model 405 may reside and execute on the server 400. The learning model 405 may be a particular implementation of the learning model 180. The learning model 405 may be a computer vision-based learning model that may employ any suitable machine learning/artificial intelligence learning methodology including, but not limited to, support vector machines, regression classifiers, neural networks (e.g., convolutional neural networks, deep learning networks, etc.), or any other suitable machine learning model/algorithm.

A SCO machine 410 is also depicted in FIG. 4. The SCO 410 may be a particular implementation of SCO 120. In example embodiments, one or more cameras 455 (which may be particular implementations of cameras 240) may capture image data of items placed on a platform of SCO 410 or otherwise in the vicinity of SCO 410. For instance, a customer may place a basket of items on a bed of SCO 410, and the cameras 455 may capture images/video of the basket of items from various orientations, angles, directions, etc.

The image data 415 captured in this manner may be provided as input to the learning model 405. The learning model 405 may have been previously trained on labeled/annotated image data to detect and identify items within images and output a corresponding item identifier (e.g., SKU 450) for each such item. In some embodiments, the learning model 405 may output item identification data 420 that includes item identifiers (e.g., SKUs) for the items detected and recognized within the image data 415. The SCO 410 may then access pricing information for the items linked to those SKUs and associate the appropriate item prices with the transaction. While an item SKU 450 is depicted as being provided by the learning model 405 to the SCO 410 independently of the item identification data 420, this is for ease of depiction. It should be appreciated that the item identification data 420 may include the item identifiers (e.g., SKUs 450) identified by the learning model 405.

In some embodiments, the learning model 405 may be unable to identify an item with a minimum required level of confidence for the SCO 410 to associate the corresponding item price with the transaction. That is, business rules/logic may require a minimum threshold level of confidence in the learning model's 405 item identification (e.g., 90%) before accepting a candidate SKU output from the learning model 405. In some cases, the learning model 405 may be unable to provide a threshold level of confidence in a SKU output because the learning model 405 has not previously seen enough images of the item during its training. This scenario may occur, for example, if an item has special event/holiday packaging that differs from the typical packaging in shape, color, or the like. In other cases, the learning model 405 may be unable to provide a SKU output at all or may otherwise provide a candidate SKU output with an especially low confidence, due to other factors such as an item not being detected at all (e.g., being occluded from a camera's view).

In those circumstances in which the item identification data 420 does not include a SKU output for an imaged item that meets a first threshold confidence level—representing a confidence level at which the SCO 410 is permitted to associate a price linked to the SKU with the transaction—additional learning input may be obtained to enhance/supplement the learning model's 405 output. In some embodiments, the SCO 410 may determine a set of candidate items to present to a customer 425 and may prompt 425 the customer 430 to select that candidate item which matches an imaged item for which the learning model 405 was unable to provide a SKU output at a suitable confidence level. The set of candidate items may include the item corresponding to the low-confidence SKU output from the learning model 405 as well as one or more other items having a known stored association with the item as a related item. Optionally, the learning model 405 may output the set of candidate items to present the customer 430. In some embodiments, the set of candidate items may be presented to the customer 430 if the SKU output from the learning model 405 fails to satisfy the first threshold confidence level (e.g., 90%), but does satisfy a second lesser threshold confidence level (e.g., 60%).

In example embodiments, representations of the candidate items (e.g., thumbnail images, graphical depictions, etc.) may be display on a display of the SCO 410. The display may be a touch screen display (e.g., display 320 and touch screen 325) capable of receiving touch input from the customer 430. In example embodiments, the customer 430 may provide touch input 435 to the SCO display corresponding to a selection of a particular candidate item or a customer-specified (e.g., via text entry) item. A corresponding SKU for the customer selection may then be determined (e.g., from item identifier data 155C) and the retrieved SKU may be associated with the transaction. In addition, enhanced item identification data 440 may be generated that associates the determined SKU with the corresponding image data of the item. The enhanced item identification data 440 is illustratively depicted in FIG. 4 as being stored in one or more datastore(s) 445, which may include local datastore(s) present within a retail environment (e.g., datastore(s) 150) and/or remote datastore(s).

In some embodiments, SCO 410 may prompt 425 the customer 430 to utilize scanner (e.g., 330) to scan a machine-readable code on packaging of an item for which the learning model 405 was unable to identify the corresponding SKU with an acceptable level of confidence. In some embodiments, SCO 410 may prompt 425 the customer 430 for scanner input 435 for an item if the learning model 405 is unable to ascertain a corresponding SKU for the item at all, or if the learning model 405 provides a SKU output that fails to satisfy both the first and second threshold confidence levels described earlier. For instance, assuming that the first threshold confidence level is 95% and the second threshold confidence level is 70%, if the SKU output from the learning model 405 is 60% for a particular imaged item, then the SCO 410 may prompt 425 the customer 430 to utilize a scanner to scan a machine-readable marking on the item. SCO 410 may then determine the SKU corresponding to the scanner input 435 that is received and generate the enhanced item identification data 440 that links the SKU to the corresponding image data of the item. In some embodiments, such as those in which the images captured by cameras integrated with or provided in proximity to SCO 410 include multiple items, the determined SKU may be stored in association with or otherwise linked to coordinates of a bounding box encompassing the item in an image.

In other example embodiments, the additional learning input may take the form of output from an alternative machine learning model. In particular, if learning model 405 is unable to provide a SKU output having a suitable confidence level, then an alternative machine learning model that utilizes a different learning technique/methodology and/or that is trained on a different training dataset, then an alternative machine learning model may be employed to provide the additional learning input for associating a SKU to an imaged item.

Regardless of the source of the additional learning input 435, the enhanced item identification data 440 generated therefrom may, in some embodiments, be provided as additional training data input to the learning model 405. The learning model 405 may then be re-trained based on enhanced item identification data to improve the accuracy and/or breadth of its item detection/recognition/identification capabilities. In this manner, additional learning input received as user/scanner input 435 at SCO 410 or as alternative machine learning model output can be used to enhance the training dataset for the learning model 405 during re-training of the model 405.

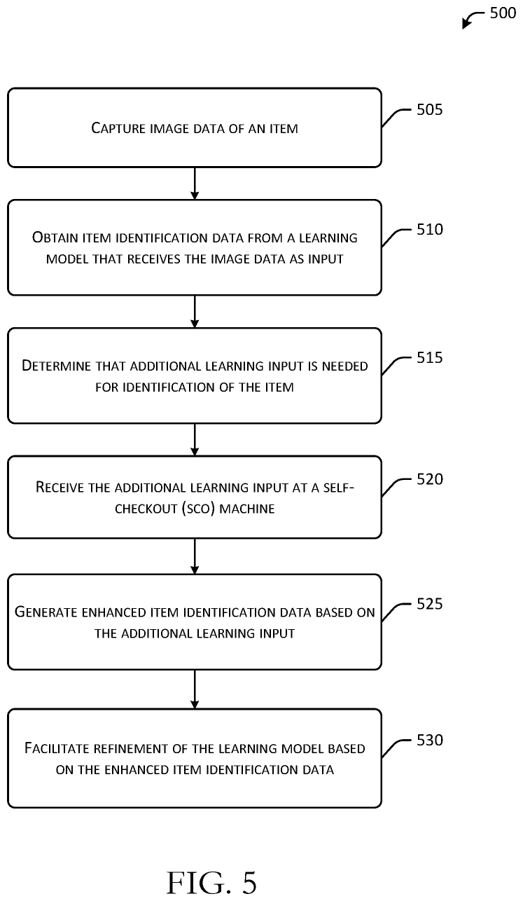

FIG. 5 is a flowchart of an illustrative method 500 of generating enhanced item identification data in accordance with example embodiments of the disclosed technology. At block 505 of method 500, image data (e.g., image data 155A, image data 415) of an item is captured. The image data may be captured by multiple cameras (e.g., cameras 240) positioned at various locations so as to capture image data from numerous angles, heights, orientations, distances, etc. The cameras may be integrated with a SCO (e.g., SCO 120, SCO 410) or may be provided externally thereto but capable of communicating with the SCO via one or more wired and/or wireless connections. The image data may include images of individual items and/or images of multiple items. For instance, in an example scenario, a customer may place a basket of items on the SCO, and the cameras may capture multiple images of the basket of items.

At block 510 of method 500, item identification data (e.g., item identification data 420) is obtained from a learning model (e.g., learning model 180, learning model 405). As previously noted, the learning model may be a computer vision-based machine learning model. The learning model may have been trained on a training dataset that includes images of items that are annotated/labeled with their corresponding known item identifiers (e.g., SKUs). In some embodiments, the item identification data may further include a confidence value/level associated with a SKU output.

At block 515 of method 500, it may be determined that additional learning input is needed to identify an item. More specifically, a SCO (e.g., processor 315 of ICIT 210 of SCO 120) may execute business logic to determine that the confidence level associated with a SKU outputted by the learning model fails to satisfy a threshold confidence level for accepting the SKU as a true identifier of the corresponding imaged item.

At block 520 of method 500, the additional learning output may be received at the SCO. As disclosed herein, the additional learning output may be user input in the form of a customer selection from a set of candidate items presented to the customer, scanner input from a scan of machine-readable indicia on packaging of an item, or a customer-specified description of the item or customer entry of an item identifier. In other embodiments, the additional learning input may be a SKU output received from an alternative learning model.

At block 525 of method 500, the SCO may generate enhanced item identification data based on the additional learning input received at block 520. The enhanced item identification data (e.g., enhanced item identification data 155B, enhanced item identification data 440) may include data that associates a SKU determined to be a true identifier of an imaged item based on the additional learning input received at block 520 with a corresponding one or more images of the item. The enhanced item identification data may be stored locally on the SCO and/or within the retail environment at which the SCO is located (e.g., on store server 140). In addition, in some embodiments, the enhanced item identification data may be used to facilitate refinement of the learning model, at block 530. For instance, the enhanced item identification data may be provided to a remote server (e.g., remote server 170) on which the learning model (e.g., learning model 180) resides and executes. More specifically, the enhanced item identification data may be provided as input to the learning model to re-train the model to improve the accuracy/breadth of its item detection/recognition/identification capabilities.

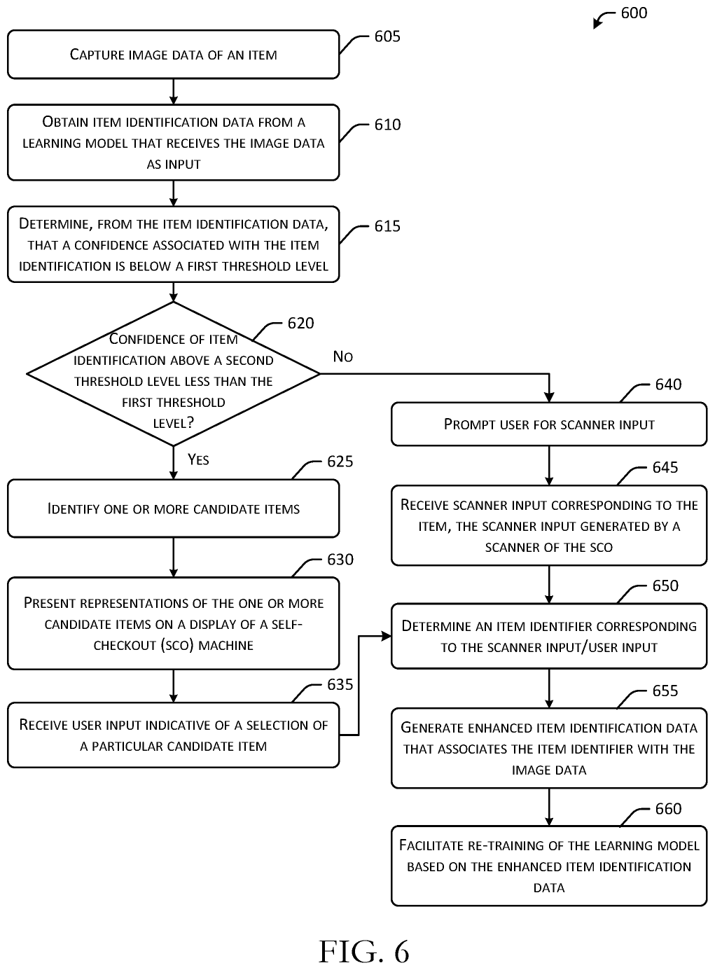

FIG. 6 is a flowchart of a specific example implementation 600 of the method of FIG. 5 in accordance with example embodiments of the disclosed technology. The operations at blocks 605 and 610 may correspond to the operations at block 505 and 510, respectively. Moreover, the operations at blocks 615-660 may represent a specific implementation of the process flow of operations 515-530. In particular, at block 615 of method 600, a SCO may determine, from the item identification data received at block 610, that a confidence value/level associated with the item identification of an item (e.g., a SKU output from the learning model) is below (or less than or equal to) a first threshold confidence level. Then, at block 620 of method 600, the SCO may determine if the confidence value/level is above (or greater than or equal to) a second threshold confidence level that is less than the first threshold confidence level.

A positive determination at block 620 may constitute a scenario in which the SKU output from the learning model does not have a high enough confidence for the SCO to accept the SKU—based on business logic—as being a true identifier of a corresponding imaged item, but the confidence is nonetheless high enough to identify and present indications of one or more candidate items that represent the actual item that the system is attempting to identify. The candidate item(s) may be identified at block 625 and representations thereof may be presented on a display of the SCO at block 630. Then, at block 635, customer input indicative of a selection of a particular candidate item or other customer input identifying another item may be received. From block 635, the method 600 may proceed to block 650, described later in this disclosure.

Referring again to the determination at block 620, if a negative determination is made (e.g., confidence associated with the item identification is particularly low, i.e., fails to satisfy the first threshold confidence level or the second threshold confidence level), then the method proceeds to block 640, where the SCO prompt the user for scanner input. At block 645 of method 600, the SCO may receive scanner input corresponding to the item sought to be identified (e.g., data read by a scanner from a machine-readable marking or indicia present on packaging of the item). The scanner input may be generated by a scanner of the SCO, based on customer manipulation/movement of the item across the scanning path of a fixed scanner or based on customer manipulation/movement of a handheld scanner.

At block 650 of method 600, the SCO may determine an item identifier corresponding to the scanner input received at block 645 or the user input received at block 635. In particular, the SCO may access item identifier data (e.g., item identifier data 155C) to lookup the SKU corresponding to a candidate item selected by the customer or to determine the SKU that matches the scanner input. Then, at block 655 of method 600, the SCO may generate enhanced item identification data that associates the item identifier (e.g., SKU) determined at block 650 with the corresponding image data of the item. If the image only includes the particular item, the enhanced item identification data may store an association between an image identifier for the image and the determined SKU. If the image includes multiple items, the enhanced item identification data may store an association between a set of attributes of the item in the image (e.g., coordinates of a bounding box around the item in the image) and the determined SKU.

Finally, at block 660 of method 600, the re-training of the learning model may be facilitated based on the enhanced item identification data generated at block 655. More specifically, the SCO may provide the enhanced item identification data as input to the learning model, based on which, the learning model may be re-trained to improve the accuracy of its item identification capabilities. The enhanced item identification data may serve as enhanced training data for the learning model.

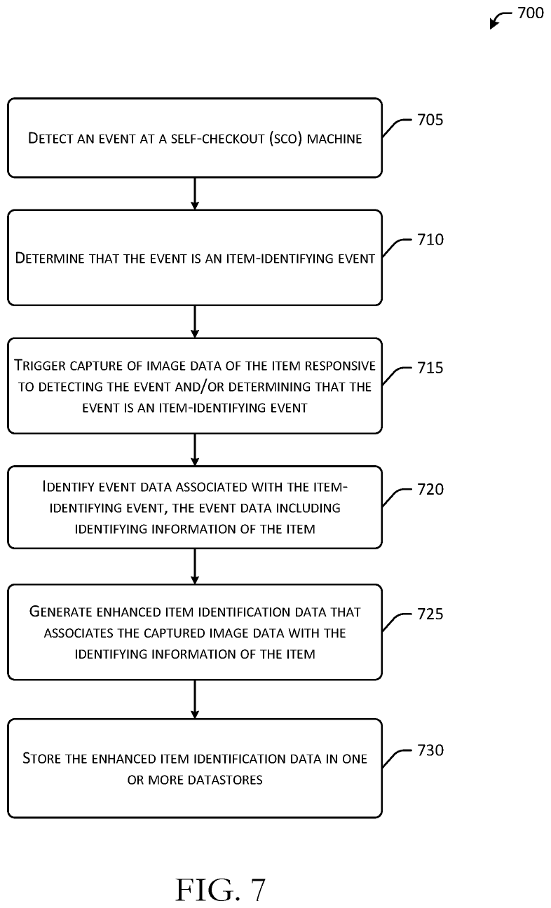

FIG. 7 is a flowchart of an example method 700 of event-triggered capture of item image data in accordance with example embodiments of the disclosed technology. One or more operations of the method 700 may be performed by a processor of a SCO machine such as processor(s) 315 (FIG. 3). Referring now to FIG. 7, at block 705 of the method 700, an event is detected at a SCO machine. At block 710 of the method 700, the event is determined to be an item-identifying event. In some embodiments, the item-identifying event may be a scan event at a SCO machine. For instance, the item-identifying event may be a scan of a barcode or other marking present on an item or item packaging using a bioptic (flatbed scanner) of the SCO machine, a handheld scanner, or the like. A processor of the SCO machine may determine that the scan event is an item-identifying event upon receiving, as input, output from the scanner that is representative of information contained within an item barcode and determining that the received information is linked to identifying information of a particular item (e.g., a SKU). For instance, the processor may access a database that stores records that link or otherwise associate information contained within item barcodes (and which is ascertainable from the received scanner output) with item identifiers such as SKUs.

In other embodiments, the item-identifying event may not be a scan event, but rather may be another type of event that nonetheless serves to identify a particular item. For instance, in some embodiments, the item-identifying event may be a user selection of a particular item from a collection of candidate items identified on a display of the SCO machine (e.g., thumbnail images of items, a drop-down menu of item names, etc.). As another non-limiting example, the item-identifying event may be other user input provided to the SCO machine that identifies an item such as free-form text input provided via a touch display of the SCO machine, voice input to the SCO, or text and/or voice input to a mobile device (e.g., a user's smartphone), which is then communicated to the SCO via a wireless connection such as a Bluetooth connection.

At block 715 of the method 700, capture of image data of the item is triggered responsive to detecting the event and/or determining that the event is an item-identifying event. In some embodiments, the image of the item may be captured responsive to detecting any of a set of predetermined events that can occur at a SCO machine, even prior to identifying the item corresponding to the event. The predetermined events may be, for example, events known to be item-identifying events. For example, the image of the item may be captured responsive to detecting a scan event, potentially prior to actually determining the SKU associated with the barcode information obtained by the scanner. As another non-limiting example, the image of the item may be captured responsive to detecting a user touch selection of a SCO display (or other user input to the SCO) in combination with detecting a weight change on a SCO weighing scale, detecting an item within a field-of-view of one or more cameras, or the like. In any case, the image data may then be associated with the item's SKU after it is determined based on the scanned barcode information, user input, or the like. In other embodiments, the image of the item may be captured after the item identifying information (e.g., SKU) is determined. In some embodiments, the image data may be captured by a camera that is embedded within a SCO scanner.

At block 720 of the method 700, event data associated with the item-identifying event may be identified. The event data may include item identifying information such as a SKU of the item, which may be determined by accessing a database that stores associations between SKUs (or other item identifiers) and corresponding barcode information of the items. Alternatively, the event data, as that term is used herein, may refer to the barcode information obtained by the scanner, and that event data may be used to determine the item identifying information (e.g., an item SKU). In other embodiments, the event data may include user input such as a selection of a candidate item presented to the user via the SCO machine, free-form text input from the user, voice input from the user, etc., which may be used to access a database and retrieve a corresponding item identifier (e.g., SKU).

At block 725 of the method 700, enhanced item identification data may be generated. The enhanced item identification data may associate the captured image data with identifying information of the item. Then, at block 730 of the method 700, the enhanced item identification data may be stored in one or more datastores, which may include a local datastore in a retail environment in which the SCO machine is located or a remote datastore such as cloud-based data storage. In some embodiments, the enhanced item identification data may be used as feedback data to re-train or enhance the item identification capabilities of a computer vision-based machine learning model. In some embodiments, the enhanced item identification data may be shared with a third party. In some embodiments, the enhanced item identification data may be annotated (either manually or through an at least partially automated process) to label various objects present in the image data. For example, objects present in the image data may be manually annotated to distinguish them from the item identified by the item identifying information of the enhanced item identification data. It will be appreciated that a “machine,” “system,” “datastore,” and/or “database” may comprise software, hardware, firmware, and/or circuitry. In one example, one or more software programs comprising instructions capable of being executable by a processor may perform one or more of the functions of the machines, datastores, databases, or systems described herein. In another example, circuitry may perform the same or similar functions. Alternative embodiments may comprise more, less, or functionally equivalent machines, systems, datastores, or databases, and still be within the scope of present embodiments. For example, the functionality of the various machines, engines, datastores, and/or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance, or vice versa. In addition, any time A (e.g., a determination, operation, process, decision, event, or the like) is described herein as being “based on” B (e.g., another determination, operation, process, decision, event, or the like), it should understood that this should be construed as A being “based at least in part on” B.

The systems, methods, processes, datastores, and/or databases described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance, or vice versa. Although individual operations of one or more methods are illustrated and described as separate operations, one or more of the individual operations may be performed concurrently, and nothing requires that the operations be performed in the order illustrated. Further, one or more operations may not be performed in some embodiments. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

What is claimed is:

1. A method of event-triggered capture of an image of an item, the method comprising:
detecting an event at a self-checkout (SCO) machine;
determining that the event is an item-identifying event;
triggering capture of image data of the item identified by the item-identifying event; and
generating enhanced item identification data that associates the captured image data with identifying information of the item.

2. The method of claim 1, wherein the image data is captured responsive to detecting the event.

3. The method of claim 1, wherein the image data is captured responsive to determining that the event is an item-identifying event

4. The method of claim 1, wherein the enhanced item identification data is stored in a local datastore in a retail environment in which the SCO machine is located.

5. The method of claim 1, wherein the enhanced item identification data is stored in a remote datastore provided in a cloud-based environment.

6. The method of claim 1, wherein the image data is captured by a camera embedded in a scanner of the SCO machine.

7. The method of claim 1, further comprising annotating the enhanced item identification data.

8. A method of item identification in connection with a self-checkout transaction, the method comprising:
determining whether an item can be identified using a first learning methodology; and
identifying the item using a second alternative learning methodology responsive to determining that the item cannot be identified using the first learning methodology.

9. The method of claim 8, wherein the first learning methodology is a computer vision machine learning model (CVMLM).

10. The method of claim 9, wherein determining whether the item can be identified using the first learning methodology comprises:
providing image data as input to the CVMLM;
receiving item identification data as output from the CVMLM; and
determining whether the item can be identified based on the item identification data.

11. The method of claim 10, wherein the item identification data comprises a candidate item identifier of the item and a confidence value associated with the candidate item identifier.

12. The method of claim 11, wherein determining whether the item can be identified based on the item identification data comprises:
determining that the confidence value fails to satisfy a first threshold value; and
determining, based on predetermined transaction logic, that the candidate item identifier cannot be accepted as a true identifier of the item for the self-checkout transaction due to the confidence value failing to satisfy the first threshold value.

13. The method of claim 12, further comprising:
determining that additional learning input is needed to determine the true identifier for the item;
obtaining the additional learning input;
determining the true identifier for the item based on the additional learning input; and
generating enhanced item identification data based on the additional learning input.

14. The method of claim 13, wherein the enhanced item identification data associates the true identifier with at least a portion of the image data that includes the item.

15. The method of claim 14, wherein the enhanced item identification data associates the true identifier with coordinates of a bounding box around the item in the image data.

16. The method of claim 13, further comprising:
re-training the CVMLM based on the enhanced item identification data to improve an item identification accuracy of the CVMLM.

17. The method of claim 12, further comprising:
determining that the confidence value satisfies a second threshold confidence level less than the first threshold confidence level;
identifying a set of candidate items;
presenting a representation of the set of candidate items on a display of a self-checkout (SCO) machine; and
receiving a selection of a particular candidate item or other input indicative of an alternative item.

18. The method of claim 17, further comprising:
accessing item identifier data to determine an item identifier corresponding to the selected particular candidate item or corresponding to the alternative item; and
generating enhanced item identification data that associates the item identifier with at least a portion of the image data that includes the item.

19. The method of claim 12, further comprising:
determining that the confidence value fails to satisfy a second threshold confidence level less than the first threshold confidence level;
prompting a customer for scanner input;
receiving the scanner input at a self-checkout (SCO) machine, the scanner input obtained from a scan of machine-readable indicia associated with the item;
accessing item identifier data to determine an item identifier corresponding to the scanner input; and
generating enhanced item identification data that associates the item identifier with at least a portion of the image data that includes the item.

20. A self-checkout (SCO) apparatus, comprising:
at least one memory storing computer-executable instructions; and
at least one processor configured to access the at least one memory and execute the computer-executable instructions to perform operations comprising:
determining whether an item can be identified using a first learning methodology; and
identifying the item using a second alternative learning methodology responsive to determining that the item cannot be identified using the first learning methodology.
